(19) United States
(12) Patent Application Publication
(10) Pub. No.: US 2026/0009443 A1
(43) Pub. Date: Jan. 8, 2026

(54) METHOD OF MAKING WET FRICTION MATERIAL USING A COATING LAYER

(71) Applicant: Schaeffler Technologies AG & Co. KG, Herzogenaurach (DE)

(72) Inventors: Murat Bakan, CANTON, OH (US); Brian Luan, Wooster, OH (US); Nathaniel Sisson, Massillon, OH (US)

(21) Appl. No.: 18/762,605

(22) Filed: Jul. 2, 2024

(51) Int. Cl. F16D 69/02; F16D 13/64

(52) U.S. Cl. CPC F16D 69/026; F16D 13/64; F16D 2200/0078; F16D 2200/0091

(57) ABSTRACT

A method of making a wet friction material layer includes saturating a base layer with a binder. The base layer includes fibers and filler particles and includes a coating layer on an outer surface of the base layer. The coating layer plugs first pores of a first subset of the filler particles and prevents the binder from entering the first pores. The method also includes melting the coating layer to unplug the first pores.

The present disclosure relates generally to friction clutches and plates used in torque converters and motor vehicle transmissions and more specifically to wet friction material.

### BACKGROUND

The friction material in wet-type friction clutches generally operates in an oil submerged environment and is often paper-based material used to form friction material rings. It is known to combine fibers and filler particles and then saturate them with a resin.

### SUMMARY OF THE INVENTION

A method of making a wet friction material layer includes saturating a base layer with a binder. The base layer includes fibers and filler particles and includes a coating layer on an outer surface of the base layer. The coating layer plugs first pores of a first subset of the filler particles and prevents the binder from entering the first pores. The method also includes melting the coating layer to unplug the first pores.

In examples, the coating layer has a melting point of between 50° C. and 100° C.

In examples, the coating layer is a wax.

In examples, the wax is a beeswax or a carnauba wax.

In examples, the method further includes, prior to saturating of the base layer with a binder: embedding the filler particles in a matrix of the fibers to form the base layer; heating a coating material above a melting point of the coating material; then applying the coating material to the outer surface of the base layer to cause the coating material to then solidify and form the coating layer.

In examples, the coating material is solidified by exposing the coating material to air having a temperature below the melting point of the coating material.

In examples, the melting point is between 50° C. and 100° C.

In examples, the applying of the coating material to the outer surface of the base layer is performed by a roller.

In examples, the coating layer encapsulates an outer-facing surface of the first subset of the filler particles and forms a continuous coating on the outer surface.

In examples, the filler particles are diatomaceous earth particles.

In examples, the binder is phenolic resin.

In examples, the melting of the coating layer is performed by applying a heat that cures the binder.

In examples, the heat that cures the binder is provided by a heat plate that is pressed against the coating layer.

In examples, the coating layer is 10 to 40 microns thick.

In examples, the base layer is 0.8 to 1.3 mm thick.

A method of making a part of a friction clutch is provided that includes melting of the coating layer by applying a heat that cures the binder and fixes the wet friction material to a metal part of the friction clutch.

A wet friction material is also provided that includes a base layer including a matrix of fibers and filler particles embedded in the matrix of fibers, a first subset of the filler particles forming part of an outer surface of the base layer; a binder embedded in the base material, first pores of the first subset of the filler particles forming not being plugged by the binder; and wax residue in the base layer offset from the outer surface.

### BRIEF DESCRIPTION OF THE DRAWINGS

The present disclosure is described below by reference to the following drawings, in which:

FIG. 1a schematically shows a base layer of a wet friction material layer before the binder is added;

FIG. 1b shows a coating material being applied to the base layer shown in FIG. 1a to form a coating layer on the base layer;

FIG. 1c shows the base layer shown in FIG. 1a after the coating layer is added to the base layer;

FIG. 1d shows the wet friction material layer of FIG. 1b after a binder is added to the base layer;

FIG. 1d shows the wet friction material of FIG. 1c on a metal part automotive drivetrain part;

FIG. 1e shows the wet friction material of FIG. 1d being attached to the metal part automotive drivetrain part by a heat plate that also melts the coating layer;

FIG. 1f shows the wet friction material of FIG. 1e after the wet friction material is attached to the metal part automotive drivetrain part and the coating layer has melted; and

FIG. 2 shows a wet friction material layer bonded to both sides of a clutch plate of lockup clutch assembly of a torque converter.

### DETAILED DESCRIPTION

The present disclosure provides a method that includes applying a temporary coating layer on an outer surface of a raw friction material in order to prevent binder from accumulating on the top surface and clogging the pores of filler particles of the raw friction material. Clogging of the pores of the filler particles negatively impacts friction properties of the wet friction material. Wax, including beeswax or carnauba wax, can be used as the temporary coating layer. Both beeswax or carnauba wax are solid at room temperature and prevent the binder from the attaching to the outer surface. After the wax is applied, it is cured at a temperature above room temperature, causing the wax to melt and opening the pores of the diatomaceous earth particles.

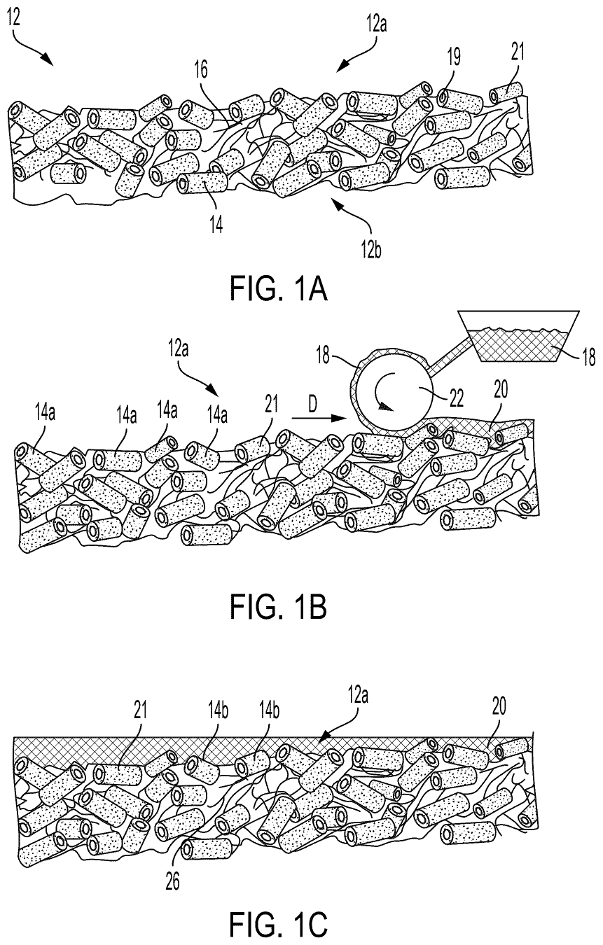

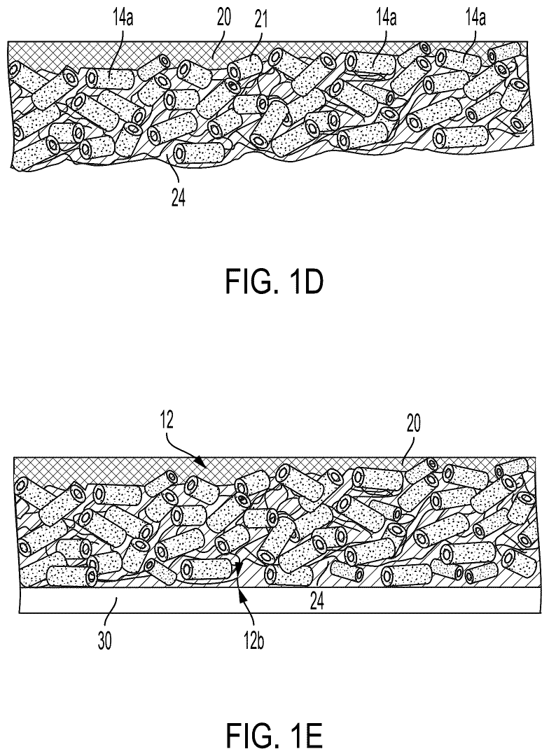

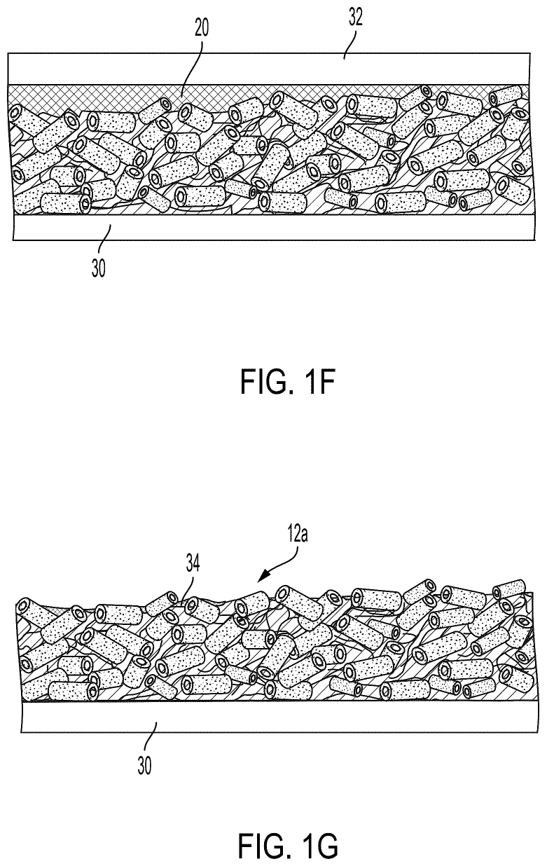

FIGS. 1a to 1g schematically illustrate a method of making a wet friction material 10 and a clutch assembly in accordance with an embodiment of the present disclosure.

A base layer 12 of the wet friction material layer 10 may be formed of fibers, filler material and a binder. The fibers can be aramid fibers, organic fibers, carbon fibers and/or fiberglass. The organic fibers may include cellulose fibers or cotton fibers. In the example discussed below, the filler particles are diatomaceous earth. The binder may be a phenolic resin. Optionally a friction modifier such as graphite may also be included in base layer 12.

In one preferred embodiment, base layer 12 may include, by percentage weight, 30 to 70% fibers, and 30 to 70% filler material.

FIG. 1a schematically shows base layer 12 before a coating material and the binder are added. Base layer 12 includes a material base formed by a plurality of diatomaceous earth particles 14 embedded in a matrix of fibers 16 between a first outer surface 12a and a second outer surface 12b of base layer 12. Fibers 16, particles 14 and any friction modifiers are joined together in a pulping process, which involves forming a mixture of the fibers 16, particles 14 and any friction modifiers submerged together in a liquid solution, then drying the mixture to remove the liquid. After fibers 16 and particles 14 are joined together by the liquid solution and dried, base layer 12 includes a matrix formed by fibers 16 and filler particles 14 that define a network of voids.

In the embodiment shown in FIG. 1a, the filler particles 14 are diatomaceous earth particles having a hollow cylindrical shape and each includes a hole 19 passing axially therethrough. Particles 14 are also porous and include a plurality of pores 21 passing radially therethrough from an inner circumferential surface to an outer circumferential surface of the respective particle 14. In other embodiments, particles 14 may have a different shape, but still include a plurality of holes and are porous.

As shown in FIGS. 1b and 1c, after base layer 12 is formed, the method includes heating a coating material 18 above a melting point of the coating material 18, then applying the coating material 18 to the outer surface 12a of the base layer 12 to cause the coating material 18 to then solidify and form a coating layer 20. The coating material 18 can be a wax having a melting point between 50° C. and 100° C. As schematically illustrated in FIG. 1b, the coating material 18 in liquid form can be fed to a roller 22 and applied to the outer surface 12a by the roller 22. The roller 22 can be rotated about its center axis and the base layer 12 can be moved in a direction D1 past the roller 22 as the roller 22 rotates.

During the applying of the coating material 18 to the outer surface 12a of the base layer 12, the coating material 18 can penetrate into pores 21 of a first subset 14a of the particles 14. The first subset 14a of the particles 14 are those that form the outer surface 12a. After solidification of the coating material 18, the penetration into the pores 21 of the first subset 14a of the particles 14 causes the coating layer 20 to plug the pores 21 of the first subset 14a of the particles 14, which subsequently will prevent the binder from entering the pores 21. The coating material 18 is solidified into coating layer 20 by exposing the coating material 18 to air having a temperature below the melting point of the coating material 18. As shown in FIG. 1c, the coating layer 20 encapsulates an outer-facing surface 14b of the first subset 14a of the filler particles 14 and forms a continuous coating on the outer surface 12a. In other words, the coating layer 20 is non-porous in the sense that liquid cannot penetrate through the coating layer 20. In other embodiments, the coating can be rubbed onto the base layer 12 in solid form.

As shown in FIG. 1d, after coating layer 20 is formed on outer surface 12a of base layer 12, the binder 24 is added to base layer 12 such that voids 26 (FIG. 1c) in base layer 12 between a matrix formed by fibers 16 and diatomaceous earth particles 14 are saturated with the binder 24. The base layer 12, with coating layer 20 thereon, can be dipped in phenolic resin and squeezed through a stainless steel roller. As noted above, the coating layer 20 plugging pores 21 of the first subset 14a of the filler particles 14 and prevent the binder 24 from entering the pores 21 of the first subset 14a of the filler particles 14. In one preferred embodiment, the coating layer is 10 to 40 microns thick and the base layer is 0.8 to 1.3 mm thick. More particularly, the coating layer can be 20 to 30 microns thick and the base layer is 1.0 to 1.1 mm thick.

As shown in FIGS. 1e and 1f, the base layer 12 is then placed on top of a metal part 30 and layer 12 and part 30 are joined together to form a friction assembly. Prior to joining of layer and part 30, the binder is subject to initial curing to a level called B-stage, where the layer 12 is somewhat flexible. The joining of layer 12 and part 30 together includes pressing base layer 12 against metal part 30 with a heat plate 32 to complete curing of the binder 24 in base layer 12, fixing base layer 12 and metal part 30 together. The force of pressing of heat plate 32 against outer surface 12a of base layer 12, while outer surface 12b of base layer 12 rests on an outer surface 30a of metal part 30, causes the binder to accumulate at an interface of outer surface 12b of base layer 12 and outer surface 30a of metal part 30, while the curing of the binder by the heat of heat plate 32 creates a permanent connection between metal part 30 and base layer 12. The heat plate 32 melts the coating layer 20 and causes binder 24 to solidify and hardens in base layer 12. In one preferred embodiment, the heat at a surface 32a of plate 32 that contacts outer surface 12a of outer layer is 375 to 425 degrees F.

The heat from heat plate 32 unplugs the pores 21 of the first subset 14a of the particles 14 by melting the coating layer 20. FIG. 1g shows the wet friction material layer 10 after the melting of the coating layer 20. More specifically, the outer-facing surface 14b of the first subset 14a of the filler particles 14 is uncovered, unplugging the pores 21 in the outer-facing surface 14b of the first subset 14a of the filler particles 14. Because the outer-facing surface 14b of the first subset 14a of the filler particles 14 is exposed, the wet friction material layer 10 has beneficial friction properties. As illustrated in FIG. 1g, after the removal of coating layer 20, the wet friction material 10 includes wax residue 34 in the base layer 12 offset from the outer surface.

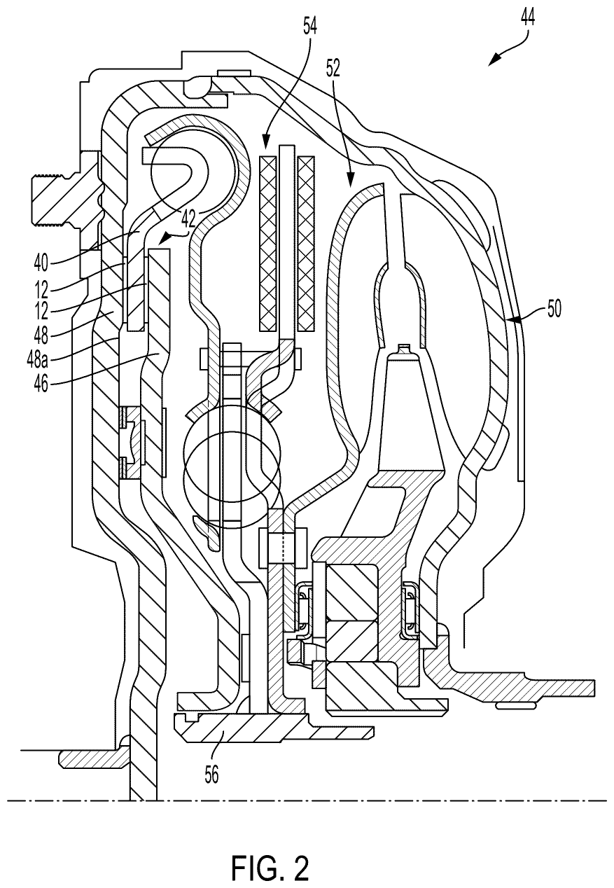

FIG. 2 shows wet friction material 10 bonded to both sides of a metal part in the form of a clutch plate 40 of lockup clutch assembly 42 of a torque converter 44. A piston 46 of lockup clutch assembly 42 forces clutch plate 40 against an inside surface 48a of a front cover 48 of torque converter 44. Piston 46 contacts the surface 12a of the rear piece of wet friction material 10 to force the surface 12a on the front piece of base layer 12 against inside surface 48a of front cover 48. The forcing of clutch plate 40 against front cover 48 by piston 46 locks the lockup clutch assembly 42 such that a torque path in torque converter 44 to a transmission input shaft bypasses an impeller 50 and a turbine 52 of torque converter 44, and instead flows from front cover 48 to clutch plate 40 and through a damper assembly 54 to a transmission input shaft that is connected to an output hub 56 of torque converter 44.

In the preceding specification, the disclosure has been described with reference to specific exemplary embodiments and examples thereof. It will, however, be evident that various modifications and changes may be made thereto without departing from the broader spirit and scope of disclosure as set forth in the claims that follow. The specification and drawings are accordingly to be regarded in an illustrative manner rather than a restrictive sense.

### List of Reference Numerals

10 wet friction material
12 base layer
12a outer surface
12b outer surface
14 particles
14a first subset
14b outer-facing surface
16 fibers
18 coating material
19 hole
20 coating layer
21 pores
22 roller
24 binder
26 such that voids
30 metal part
30a outer surface
32 heat plate
32a surface
34 wax residue
40 clutch plate
42 lockup clutch assembly
44 torque converter
46 piston
48 front cover
48a inside surface
50 impeller
52 turbine
54 damper assembly
56 output hub

What is claimed is:

1. A method of making a wet friction material layer comprising:
saturating a base layer with a binder, the base layer including fibers and filler particles and including a coating layer on an outer surface of the base layer, the coating layer plugging first pores of a first subset of the filler particles and preventing the binder from entering the first pores; and
melting the coating layer to unplug the first pores.

2. The method as recited in claim 1 wherein the coating layer has a melting point of between 50° C. and 100° C.

3. The method as recited in claim 1 wherein the coating layer is a wax.

4. The method as recited in claim 3 wherein the wax is a beeswax or a carnauba wax.

5. The method as recited in claim 1 further comprising, prior to saturating of the base layer with a binder:
embedding the filler particles in a matrix of the fibers to form the base layer;
heating a coating material above a melting point of the coating material; then
applying the coating material to the outer surface of the base layer to cause the coating material to then solidify and form the coating layer.

6. The method as recited in claim 5 wherein the coating material is solidified by exposing the coating material to air having a temperature below the melting point of the coating material.

7. The method as recited in claim 6 wherein the melting point is between 50° C. and 100° C.

8. The method as recited in claim 5 wherein the applying of the coating material to the outer surface of the base layer is performed by a roller.

9. The method as recited in claim 5 wherein the coating layer encapsulates an outer-facing surface of the first subset of the filler particles and forms a continuous coating on the outer surface.

10. The method as recited in claim 1 wherein the filler particles are diatomaceous earth particles.

11. The method as recited in claim 1 wherein the binder is phenolic resin.

12. The method as recited in claim 1 wherein the melting of the coating layer is performed by applying a heat that cures the binder.

13. The method as recited in claim 12 wherein the heat that cures the binder is provided by a heat plate that is pressed against the coating layer.

14. The method as recited in claim 1 wherein the coating layer is 10 to 40 microns thick.

15. The method as recited in claim 14 wherein the base layer is 0.8 to 1.3 mm thick.

16. A method of making a part of a friction clutch comprising:
making the wet friction material with the method as recited in claim 1,
the melting of the coating layer includes applying a heat that cures the binder and fixes the wet friction material to a metal part of the friction clutch.

17. A wet friction material comprising:
a base layer including a matrix of fibers and filler particles embedded in the matrix of fibers, a first subset of the filler particles forming part of an outer surface of the base layer;
a binder embedded in the base material, first pores of the first subset of the filler particles forming not being plugged by the binder; and
wax residue in the base layer offset from the outer surface.

18. The wet friction material as recited in claim 17 wherein the filler particles are diatomaceous earth particles.

19. The wet friction material as recited in claim 18 wherein the binder is phenolic resin.

20. A clutch assembly comprising:
a metal part; and
the wet friction material as recited in claim 17 fixed on the metal part.
